(19) United States
(12) Patent Application Publication
(10) Pub. No.: US 2013/0151426 A1
(43) Pub. Date: Jun. 13, 2013

(54) REGULATORY LABEL COMPLIANCE APPARATUS AND METHOD

(71) Applicants: Jenny Ann Whelan, South Ogden, UT (US); Phillip M. Adams, Afton, WY (US)

(72) Inventors: Jenny Ann Whelan, South Ogden, UT (US); Phillip M. Adams, Afton, WY (US)

(21) Appl. No.: 13/693,783

(22) Filed: Dec. 4, 2012

Related U.S. Application Data
(60) Provisional application No. 61/570,235, filed on Dec. 13, 2011.

(51) Int. Cl. G09F 3/00; G06Q 30/00

(52) U.S. Cl. CPC G09F 3/00; G06Q 30/018
USPC 705/317; 40/299.01

(57) ABSTRACT

An apparatus and method for labeling products may be applied to vehicle labeling, where complying with legal requirements of one jurisdiction may otherwise violate legal requirements within a second jurisdiction. Label content, format, and placement on vehicles, as imposed by federal law, creates a visual obstruction in violation of state law when a prospective customer is driving the vehicle. A new product label configured as a panel, which may be the Monroney sticker for a vehicle, or which may contain the Monroney sticker information and extend beyond that label itself, acts as a one-way panel. The panel permits transmission of light inward toward the driver, thus appearing sufficiently transparent not to create a visual obstruction. The panel may be sized from the size of a conventional Monroney sticker, up to the size of the entire window, acting as a window shade and a window sticker.

### RELATED CASES

This application: claims the benefit of co-pending U.S. Provisional Patent Application Ser. No. 61/570,235, filed on Dec. 13, 2011; which is hereby incorporated by reference.

### BACKGROUND

1. The Field of the Invention

This invention relates to product labeling and, more particularly, to novel systems and methods for providing labels to comply with legal requirements.

2. The Background Art

In 1955, Senator Mike Monroney of Oklahoma was named to head a committee investigating various unsavory practices common to automotive manufacturers and resellers (dealers). The amount of money charged to dealer franchisees was in question, including shipping charges from the manufacturing plants to the dealerships. As the committee investigated the practices of franchisors and franchisees, they investigated certain consumer protection for buyers.

Ultimately, the investigation resulted in a bill sponsored in 1958 by Senator Monroney called the Automobile Disclosure Act of 1958. That Act required, and still requires, certain labeling to be included on all automobiles and road vehicles sold. Among other things, it is required to place a label, commonly referred to as a window sticker or Monroney sticker on either a side window or the windshield of every new car offered for sale. By statute, that label or sticker can only be removed by the consumer who purchases the vehicle.

Among other things, the included information on the label or sticker must cover certain basics. That information has changed over the years. Currently, a Monroney sticker actually includes several labels within it. For example, the sticker or label will typically include information about the manufacturer, logos, name, manufacturing plant, destination to which the vehicle is shipped, destination charges, and so forth.

However, there is other information that is required regardless of whatever else is presented. For example, a manufacturer's suggested retail price (MSRP) must be included. Likewise the specifications for the engine and transmission in the vehicle must be provided. Moreover, lists of all standard equipment as well as all optional equipment, in separate lists, are included along with the pricing for each item on the list. Likewise, warranty details are included.

In recent decades, the Environmental Protection Agency (EPA) has undertaken to test vehicles and require testing for city fuel mileage, highway mileage, and the like. Accordingly, fuel economy ratings must be included in their own format and labeling region of the Monroney sticker.

Moreover, in September 2007, the National Highway Traffic Safety Administration (NHTSA) began requiring crash test ratings. These are reported for frontal impact, side impact, rollover, and so forth on a government safety-rating label.

Various countries have created their own requirements. For example, both Australia and the European Union require carbon dioxide emissions to be listed. Moreover, the EPA in the United States has proposals pending for additional ratings for carbon dioxide emissions, fuel types, gas guzzler ratings, gas guzzler tax notices, and the like. The Code of Federal Regulations (CFR) contains many pages of text and proposed labels to be placed on vehicles by legal requirements in their regulations.

In modern commerce, many cars are manufactured in a particular state or province of one country and shipped to a market in another province and/or country very different from that of the manufacturer, including legal and/or regulatory labeling requirements. Labeling, for example, is required to be placed on vehicles by manufacturers. Sellers must also comply with certain requirements. Meanwhile, certain warnings for safety, proper use of features, such as 4-wheel drive, car seat anchors and placement for infants, and so forth are also included at various places in vehicles. The plethora of regulations crossing jurisdictional boundaries has the potential for conflicts.

Moreover, another safety conflict exists by virtue of the labeling requirements for the Monroney sticker. For example, EPA regulations requiring gas-guzzler notifications and other notices have added stickers in addition to the Monroney sticker immediately to vehicles for sale. In addition, the placement of a Monroney sticker is often beside the face of the driver on the left side, driver's side, of a vehicle. As a result of its location, the included angle covered (subtended) by a standard sheet of paper, the common size of a Monroney sticker, is effectively an obstruction creating a massive blind spot out the driver's side window. In the event that the placement of a Monroney sticker is placed on the right side, passenger's side, of a vehicle, the sticker creates an obstruction, a massive blind spot, out of the passenger's side window. Placing a Monroney sticker on the front windshield is equally hazardous, creating an obstruction for the driver in the direction of forward motion of the vehicle.

Meanwhile, states require safety regulations to be enforced by police, resulting in citations being issued to individuals who have obstructions like stickers, signs, fuzzy dice, frost, or the like blocking their windows. Laws prohibit obstructive items in the windows or in certain places within the confines of a vehicle, and so forth.

As a matter of fact and law, a vehicle test drive of a vehicle with a Monroney sticker applied to any of the three aforementioned locations (i.e., driver's side, passenger's side, or front window) is in violation of state and/or federal law requiring an unobstructed view through the vehicle's windows and windshield.

Meanwhile, various stickers are placed in order to provide information, comply with regulations, and inform customers. However, each of these, to a greater or lesser extent, creates some obstruction.

What is needed is a system for reconciling the jurisdictional conflicts between the requirements placed on manufacturers and the requirements placed on vehicle retailers (dealers) and drivers who may be in a completely separate jurisdiction and subject to different or additional laws than the original vehicle manufacturer. What is also needed is an apparatus and method for effecting compliance, such that a manufacturer and/or dealer may provide compliant Monroney stickers on vehicles, that will reconcile the differences in jurisdictional requirements while still meeting actual safety needs as well as standards of safety and standards of labeling.

### BRIEF SUMMARY OF THE INVENTION

In view of the foregoing, in accordance with the invention as embodied and broadly described herein, a method and apparatus are disclosed in one embodiment of the present invention as including a system and method for creating Monroney stickers.

In certain embodiments, the Monroney sticker may be made of a material that is transparent or partially transparent, sufficiently that the Monroney sticker operates as a shade. Accordingly, an individual inside a vehicle may see out through the Monroney sticker, while still allowing an observer outside the vehicle to read the content of the sticker. In some embodiments, perforated fabrics, perforated films, and the like may be used. In others, a perforated or discontinuous pigment application may provide the ability of light to pass both ways through the window, allowing the driver from inside the vehicle to see a sufficient fraction of the much more intense light from outdoors coming through the Monroney sticker.

In some embodiments, clear film may be used with printing that is perforated, or dotted, in order to increase the void fraction that is not inked on the sticker. Accordingly, light may pass through to the driver, giving the driver vision through the sticker, even though the sticker reflects outdoor light and provides all the information of the Monroney sticker in a readable, clear format to a perspective purchaser.

In certain embodiments, labels have been reconciled as to the jurisdiction of manufacture, as well as the jurisdiction of delivery. In certain embodiments, a computer system maintains a database with engines to manage the database, as well as comparison modules or engines and reconciling systems that will reconcile the requirements of various jurisdictions, the requirements of labeling, and provide layouts for a proper monroney sticker that will comply with the requirements of all pertinent jurisdictions. Moreover, a broker module may determine priorities between regulations, in order to consolidate requirements as much as possible and to give preference to the controlling regulation or statute.

A database may maintain records, and may acquire information from manufacturers, marketers, transport providers, governmental jurisdictions, as well as private and public sources of information. Accordingly, a compliant system may provide labels, for example, Monroney stickers, that have acknowledged the pertinent jurisdictions, extracted the laws and requirements of those jurisdictions, complied with the labeling, content, size, formatting, fonts, and so forth as laid out in the law, and laid out a fitted Monroney sticker that meets the requirements of the pertinent jurisdictions, such as the manufacturer's jurisdiction and the purchaser's jurisdiction.

In one embodiment of a method for labeling a vehicle, the method may include obtaining a first regulatory information directed to at least one of content, format, and application of a product label. Then, identifying a product whose labeling falls within the scope of the first regulatory information and a second regulatory information directed to use of the product, one may find a conflict in compliance between the first and second regulatory information. Therefore, identifying a requirement of one of the first and second regulatory information that causes a violation of another requirement in the other gives rise to providing a label structure removing the violation.

In certain embodiments, providing a label structure involves designing or changing the structure of the label. This may include changing a material forming a substrate for the label, a printing process printing the content onto the substrate, or both. Thus, this may require selecting a new substrate material to replace older materials used conventionally in the fabrication of the label.

The new substrate material may be selected from a plastic film, fabric, or the like, or even simply the window of a vehicle on which the sticker can be printed directly. The labeling technique replaces the old substrate material, usually paper.

The new substrate material, ink, other printing medium, or any or all of them may be provided with perforations sized and spaced to transmit a substantial portion of light striking the label. For example, a new printing process may make the label directly on a window, or one may apply the new printing process on the substrate in a fabrication process for the label. The printing process may provide dots, lines, borders of dots, or a combination as the pigmented portion. Printing, the substrate, or both may leave voids in an application of pigment in order to transmit light through the label. Thus, the substrate, the printing process, or both effect a substantial increase in transmission of light striking the label.

As a sheet that will fit against a window, the label has two faces, a printed face containing printing and a substrate face opposite the printed face. If printing on a window, the printed face may be the substrate face, since printing may be done on either side of a window. It is more convenient to print right on the outside of a window, but print could be done on the inside surface of a window.

The label appears effectively transparent when viewed from outside the window, which would be the substrate face if a separate substrate were used. The ink, substrate, or both may be washable or may be water soluble to be removable by a purchaser. In one embodiment, the label may be removed by removing the substrate from the window. If formed as a decal, a solvent, scraper, water, or other technique corresponding to the particular application method may remove the label.

In use the printing appears opaque when viewed from outside the vehicle, the printed face for a panel applied inside a window. One way of removing the regulatory violation is by changing the structure of the label by altering a function, feature, material, or application process for the label. Altering may include substitution of a material, or process in a way that avoids violating or changing another provision either regulatory scheme of the first or second regulatory information.

Substitution of a material or process may need only to change a parameter or characteristic thereof. So long as this is within scope of applicable regulations or the regulation is silent, this does not cause any violation.

A panel may be made of the same size as a label, or larger. It may include a substrate presenting a first face to receive printing and a second face opposite. If the panel is configured to transmit light through the first face, it should be a sufficient and substantial fraction of light impinging on the first face, so as to render the panel effectively transparent.

Labeling information in compliance with the first regulatory information may then be printed on the label or as the label on the first face.

Applying the panel to a window of a vehicle may be done with any suitable materials and manner, such as glue, fasteners, adhesives, solvents, water, and electrostatic adhesion. However, regulations' requirements for non-removal should be observed by making the securement method and materials consistent with those requirements. For example, applying the panel with the printed label on it may be adhered by applying a transparent adhesive, soft or rigid to the first face, the window, or both.

In use, the panel acts as a window shade, wherein the substantial fraction of light transmitted is selected to cause the panel to act as a window shade, yet still appear transparent. Attention to formatting the printing, and the labeling information may require providing a label boundary containing the labeling information. Then, the panel may be formed to be coextensive with the label boundary or to extend beyond it, up to and including the entire shape of the window to which applied. This would typically be the driver's side or passenger's side window. However, labels are typically applied to front windshields of convertible vehicles.

The panel may be formed to a shape defined by borders corresponding generally to a shape of the window, with or without matching the window exactly. The label boundary shapes and distances may thus be of a generally rectangular shape spaced from the edges or a rear side window, or trapezoidal shape whose edges are spaced away from the edges of a front side window. Thus, the area covered by the panel may be selected to effectively provide consistent and substantial shading over a large portion of the window beyond the label itself.

The borders of the panel may enclose at least half the area of the window, or even be effectively coextensive with the window.

A particular benefit of an apparatus and method in accordance with the invention is that the first regulatory information may fall within a first jurisdiction, while the second regulatory information may fall within a second jurisdiction distinct from the first jurisdiction and not accountable to the first jurisdiction directly or indirectly. That is, treaties are indirect accountability, as is state compliance with national directives by funding or coercion. However, some states and provinces in some national government schemes are simply subsets of the national government and accountable thereto. In the United States, a state is not accountable to the federal government under the constitutional scheme of federalism.

Often, the first jurisdiction is a first nation and the second jurisdiction is a second nation, separate, sovereign, and distinct from the first nation.

In one embodiment, designing a label to reconcile compliance with the conflicting regulatory schemes and information may be a matter of making a label into a one-way window or window shade. This may be used on a window or windshield, but would be more appropriate on a driver's side window, or other window in the vehicle. For example, many techniques may be used to create a see-through or one-way panel covering most of a window, and having the label printed to be viewed from outside the vehicle. Thus, the eyes of a user need only become accustomed to one level of light intensity coming through that window. Currently, opaque labels coincide with the height and fore-to-aft location of a driver's head, thus creating a major visual obstruction. The invention permits the panel to be positioned to correspond to the head of a driver of the vehicle, while still providing visibility there through.

An apparatus acting as a label may be formed as a combination product label and window shade. A panel, having a first face and a second face may have a label, formed as a product label, and printed on the first face. Printing or printed material of the label presents the required information corresponding to regulatory information. This may be directed to content, format, application, location, or all thereof, corresponding to the product label. With the panel and printing together formed to be effectively transparent in use, when viewed from the second face the panel acts as a sunshade against transmission of light impinging against the first face. The panel may be sized to be more or less effective in this secondary function.

Formed of a material such as plastic film, fabric, and another material, the panel may be transparent, even as transparent as glass, or even more so. Pigments may be applied in layers to help eliminate the detection of the printing of a first pigment applied to act as a background from the printing of a second pigment acting as the printed material of the label. Thus, the first pigment may act as shading, obscuring substantially a view of the second pigment when viewed from the second face.

The printing, the substrate, or both may provide gaps in coverage, such as circles, borders of circles, stripes, diamonds or other effective shapes. The gaps transmit light impinging thereon, whereas the printing blocks or reflects enough of the light impinging thereon from the direction of the first face. This may be most of the light impinging on the printing, but need not be. Due to the great difference in light intensity, only a small fraction of light need by reflected or absorbed to make the printing visible from outside where the sun provides more than adequate light. Thus enough light may be transmitted to make the panel transparent. In fact, in some embodiments, the pigments, and thus the entire printed matter, may be transparent when viewed from inside the vehicle by the driver. In some embodiments, a ghost-like image may be seen by a driver, which may be sufficiently low in contrast to provide no significant visual distraction, and certainly not a visual obstruction. Thus, from inside it simply appears as slight variations in shading.

Absorptivity and reflectivity of the printing may be effective in combination to block at least half the light impinging thereon. This makes the printing visible from outside. However, levels as low as 10 percent to 25 percent are effective as observed in one-way windows, glass, mirrors, transparent printing, and the like. It is more important that the panel be formed of a material effective to reflect sufficient light to appear as a contrasting color with respect to the printing. That may be fully transparent film, the window, tinting, or another background color. Thus, the printing and background may be transparent, provided with gaps, both, or one may be more reflective or more absorptive than the other.

Thus, so long as the printing can be read and a driver can see effectively out through the label, the functionality needed to comply with labeling regulations and driver vision obstruction regulations, the needs of compliance with both kinds of regulations may be met. By regulation is included statutory, regulatory, or other legal requirements. Thus, by regulation is not necessarily meant a rule of a regulatory agency. Nevertheless, regulatory agencies are usually responsible for implementing laws, by promulgating regulations effecting the laws.

One may provide a combination product label and window shade as a panel, having a first face and a second face, with a label printed on the first face presenting information required by regulation, discretionary information from a seller or manufacture, or both. Effectively transparent in use, when viewed from the second face, the panel may be formed and shaped to provide a sunshade within the field of view of a driver or passenger of the vehicle

Thus, the panel applied to a vehicle serves as one implementation of a method for complying with conflicting laws. Selecting a vehicle requiring a product label, restricted to positioning permanently during display and removable only by a purchaser, may be effected by positioning the product label where it restricts at least a portion of the field of view of a driver of the vehicle. Then, by selecting a substrate (sheet, layer, etc.), having a first and a second surface, an imaging process, and labeling information corresponding to and complying with a regulatory information requirement applicable thereto, one may provide a label made by a suitable imaging process.

A prospective customer acting as a driver of the vehicle can read the label when observing it from outside the vehicle, but has no inappropriate obstruction of vision inside, even if the label is positioned within the field of view. This results from, and is effected by the panel on which the label is printed, or perhaps the label itself, operating as a sunshade, effectively transparent to the driver.

In one aspect of the invention, a compliance computer system having a processor and memory, a computer readable storage medium may have a network connection effective to operably connect the compliance computer system to an internetwork. Through the internetwork it may be further operably connected to other computers. These may include, for example, a manufacturing computer corresponding to a manufacturing plant producing a product, a first source computer corresponding to a first source of first legal requirements enforceable by a first governmental agency corresponding to a first jurisdiction, and a second source computer corresponding to a second source of second legal requirements enforceable by a second governmental agency, corresponding to a second jurisdiction. The first and second jurisdictions may be one and the same jurisdiction in a simplified form of the invention.

The memory stores, for execution by the processor, a jurisdiction module effective to obtain from the first source computer and the second source computer the first and second legal requirements, respectively. The memory may also store, for execution by the processor, modules comprising a reconciling module effective to compare and reconcile the first legal requirements against the second legal requirements. The compliance computer system is typically programmed to provide to the manufacturing computer a compliance instruction effective to comply with both the first and second legal requirements.

The compliance instruction represents content and format of a label to be placed on the product, rendering the product compliant with the first and second legal requirements. Also provided within the system is a method of creation or application that makes possible the compliance with the first and second legal requirements.

One exemplary product is a motor vehicle, wherein the label is a Monroney sticker. The first and second jurisdictions may be two independent nations, a nation and a state, or the like. Many provinces of nations export cars to provinces or state of other nations. These different jurisdictions of source and destination may have different, even conflicting legal requirements on labeling and operation of the vehicles. Again, a simplified example may consist of the first and second jurisdictions being one and the same jurisdiction.

The first governmental agency may be a legislative body, a regulatory body, an administrative body, an enforcement body, or the like. A jurisdiction may be a nation, a state, a province, a collection of nations, signatories to a treaty, a geographical region, a field of subject matter jurisdiction, or the like. In certain presently contemplated embodiments the various jurisdictions and agencies are not accountable to each other. Specifically the source and destination jurisdictions, or the first and second governmental agencies may be independent or otherwise not accountable to one another, in one or both directions of the relationship.

Legal requirements comprise sets of attributes or requirements, parameters, provisions, or the like. Logical processing modules (executables, or executable instructions executable by a computer) may include a comparison module instructing the processor of a compliance system to select and align the first and second sets by attribute. A comparison module may find, in the first and second sets of regulatory information first and second values, respectively, for comparing corresponding attributes in the first and second sets.

A broker module may execute on the processor to determine precedence between differences between the first and second values. A layout module may provide a layout of labeling information for the product. An output module may provide to the manufacturing computer the labeling information and the layout reflecting a labeling format for the product. The labeling information, its format, and its application process thereby render the label compliant with the first legal requirements and the second legal requirements, which are typically from the first and second jurisdictions. However, in the nature of laws, sometimes one may find such reconciliation useful between legal requirements of a single jurisdiction.

A database, operably connected to the processor may store legal records corresponding to the first and second legal requirements, product records corresponding to a specification for the product, and label records corresponding to at least one of placement, size, format, and content of a label reflecting the labeling information.

A system may include a compliance computer system comprising a processor and memory, the memory comprising a computer readable storage medium, and a network connection effective to operably connect the compliance computer system to an internetwork. The internetwork may be further operably connected to a manufacturing computer corresponding to a manufacturing plant producing a product.

The processor may operably connect to a first source computer corresponding to a first source of first legal requirements enforceable by a first governmental agency corresponding to a first jurisdiction and a second source computer corresponding to a second source of second legal requirements enforceable by a second governmental agency, corresponding to a second jurisdiction. The memory stores, for execution by the processor, a jurisdiction module effective to obtain from the first source computer and the second source computer the first and second legal requirements, respectively. Memory devices, one or many computer readable storage devices may store for execution by the processor, various modules, such as a reconciling module effective to compare and reconcile the first legal requirements against the second legal requirements, and the like.

The compliance computer system may connect to provide to the manufacturing computer a compliance instruction showing how to label to comply with both the first and second legal requirements. Typically, the compliance instruction represents content, format, manufacture, printing, application, and location of a label to be placed on the product, rendering the product compliant with the first and second legal requirements.

One such product is a motor vehicle. Once such label is a Monroney sticker. Such first and second jurisdictions are two independent nations. Another example is a nation, such as the United States and a state within that union. A further example is a state within the United States and the same state within the united States. An example of a governmental agency may be a legislative body such as Congress, a regulatory body such as the EPA, NHTSA, or the like, and an administrative body such as a department of motor vehicles, an office of an inspector general, or a police agency.

Examples of a first jurisdiction include a nation, a state, a province, a collection of nations, signatories to a treaty, a geographical region, and a field of subject matter jurisdiction. Examples of second governmental agencies may be a legislative body, regulatory body, administrative body, or the like, typically independent from and not accountable to the first governmental agency. The second jurisdiction may be likewise of any of the types for the first.

First and second legal requirements comprise attributes, which a comparison module may select and align to create or find, in first and second sets, first and second values by which to compare corresponding attributes from the first and second sets.

A broker module, is executable by the processor to determine precedence between differences between the first and second values, a layout module to provide a layout of labeling information for the product, an output module to provide to the manufacturing computer the labeling information and the layout compliant with the first and second legal requirements that would otherwise be in conflict.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of one embodiment of a computer system and network for implementing the invention;

FIG. 2 is a copy of an actual Monroney sticker, or, in general, a regulatory label or regulated product label required on vehicles in the United States;

FIG. 3 is a collection of images representing various regulated labeling required for products, specifically for automobiles in this example;

FIG. 4 is a schematic diagram of a compliance system implementing a method in accordance with the invention;

FIG. 5 is a schematic block diagram of certain nodes in accordance with FIGS. 1 and 4, implementing a compliance computer system in accordance with the invention;

FIG. 6 is a schematic block diagram of a computer and a database, which may be hosted within the computer or on a remote computer accessible for implementing the collection, saving, and use of informational records in certain embodiments in an apparatus and method in accordance with the invention;

FIG. 7 is a schematic block diagram of information saved in a database, for use in operating a compliance computer system of FIG. 5, through a system of FIG. 6, in order to provide compliance with regulatory labeling of products;

FIG. 8 is a schematic block diagram of modules and a process for reconciling jurisdictional discrepancies and integrating that information with manufacturer's information in order to provide product labeling and regulatory compliance;

FIG. 9 is a schematic block diagram of a method for implementing one embodiment of a system and method in accordance with the invention;

FIGS. 10A, 10B, and 10C are schematic diagrams of certain alternative methods for implementing labeling in accordance with the invention;

FIG. 11 is a schematic image of a vehicle illustrating various locations in which labeling may be located;

FIG. 12 is a spatial schematic diagram illustrating the subtended angle, and effective blind spot created by labeling, which may be ameliorated by making labels in accordance with certain embodiments of an apparatus in accordance with the invention;

FIG. 13 is a left side elevation view of an automobile illustrating various embodiments of labels therein, these located on side windows;

FIG. 14 is a rear elevation view of a vehicle showing implementation of a label in accordance with the invention;

FIG. 15 is a right side elevation view of the inside of the vehicle of FIG. 13 illustrating the appearance of the labels in accordance with the invention;

FIG. 16 is a front elevation view of the labeling of FIG. 14 viewed from inside the vehicle; and

FIG. 17 is a left side elevation view of an alternative embodiment of a labeling system in accordance with the invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

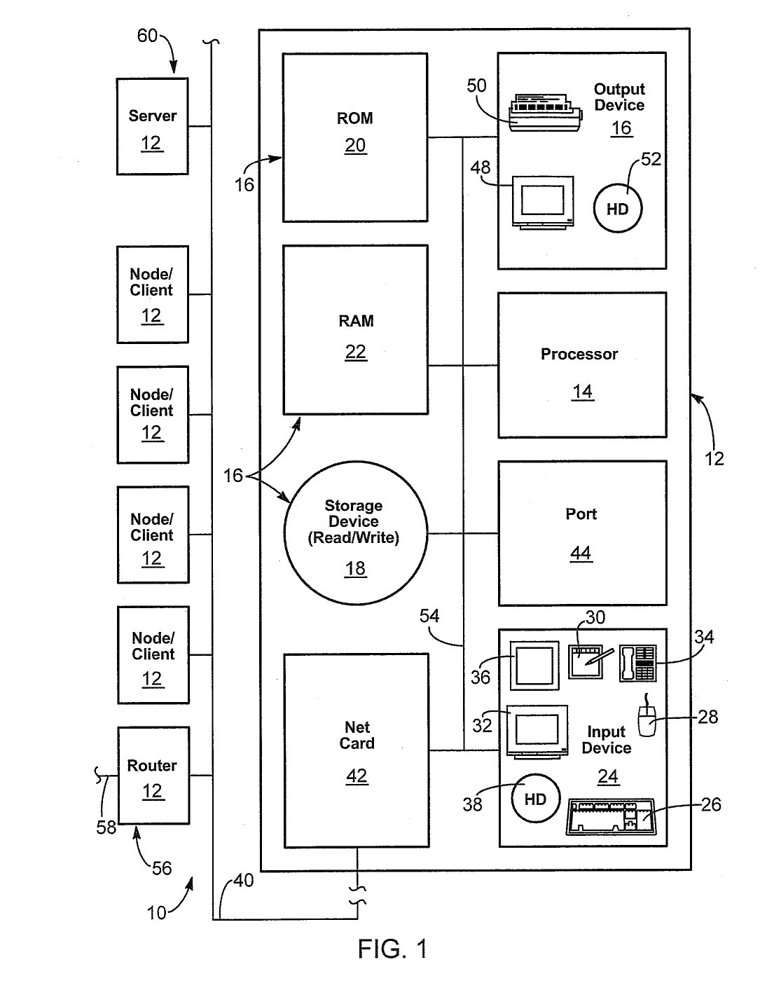

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38, including storage associated with cloud computing, may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

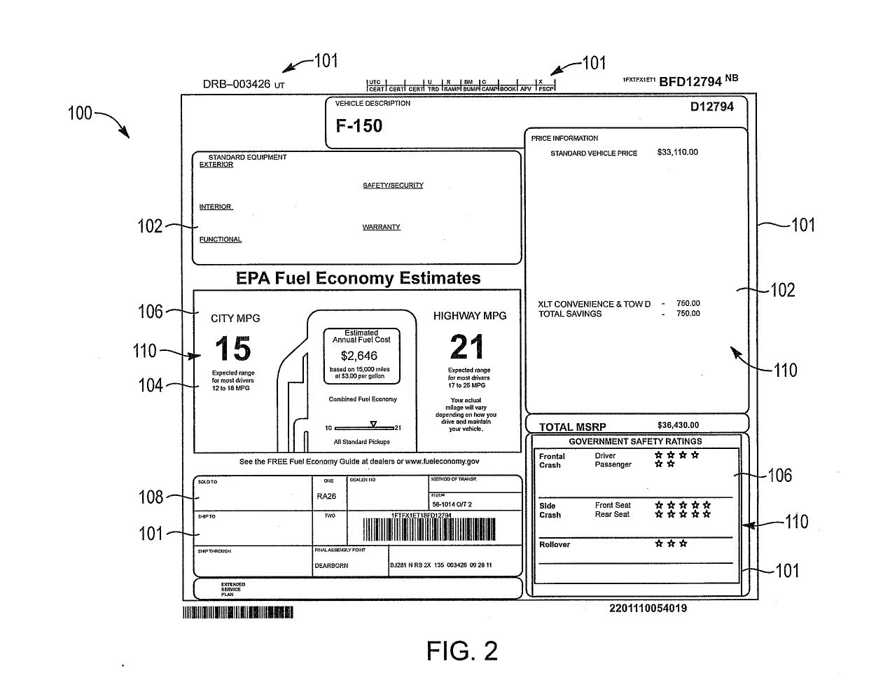

Referring to FIG. 2, a regulated product label 100, in this example, a “Monroney sticker,” is illustrated. Nevertheless, other regulated product labels may also be included within the scope of the invention. For example, medicines, certain fabrics, upholstery, clothing, and the like also have labels. However, several difficulties converge as introduced by a regulated product label such as the Monroney sticker as a specific example.

The label 100 or sticker 100 includes several fields 101, which themselves include several other required labels. For example, a manufacturing label 102 is also a regulatory label 110 filling one of the fields 101. It includes information, including regulated label data such as the specification for the vehicle. Standard equipment, optional equipment, with the price of each, as well as warranty information, is required by law. Law requires standard equipment, optional equipment, with the price of each, as well as warranty information. Accordingly, it is all provided in the manufacturing region 102 of the label 100.

Here, the manufacturing area 102 actually includes two different fields 101. One field 101 includes the optional equipment and the total price. Another portion of the manufacturing region 102 provides a list of standard equipment, warranty information, safety equipment, and the like.

Fuel information 104 or a region 104 devoted to EPA fuel economy and emission requirements is also included. In this embodiment, the city mileage, highway mileage, and certain disclaimers, as well as a ranking with respect to other vehicles, are all included within the fuel economy region 104. In recent years, the fuel economy label 104 has itself become a dominant feature of the label 100.

Likewise, safety rating 106 or a safety region 106 is included in another field 101 on the label 100. This particular regulatory label 110 is itself another label required by law, and incorporated within the overall label 100. In some embodiments, certain regulatory labels 110 may be separate labels 100, on their own. For example, on the vehicle to which the label 100 of FIG. 2 pertains, an additional label regarding certain fuel consumption ratings was posted on the vehicle, occupying almost as much space as the label 100.

In addition, certain other fields 101 include administrative information, such as the manufacturing plant, shipping costs, the destination to which a vehicle is shipped, as well as the very basic vehicle identification number (VIN) that is effectively the identifier by which the vehicle identified in the label 100 will be known throughout its entire life.

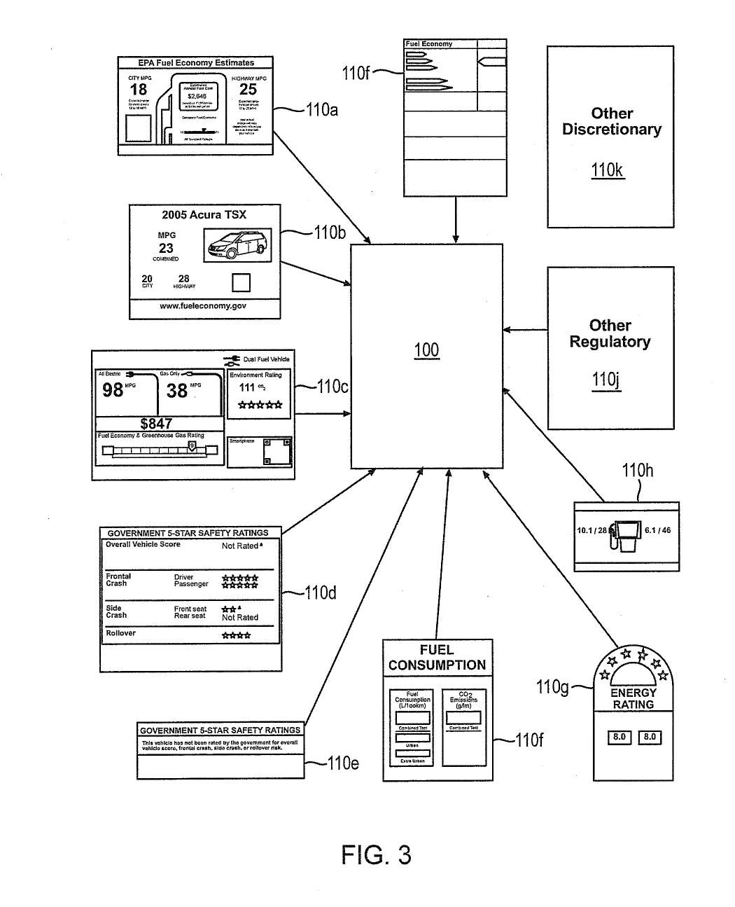

Referring to FIG. 3, while continuing to refer generally to FIGS. 1-17, various labeling is required by various jurisdictions around the world. For example, a sample of a fuel economy label 110a may be incorporated in or be added to a basic regulatory label 100. Meanwhile, a new label 110b has been developed for application to used vehicles.

Where an owner does not have a manufacturer's label but desires to label the vehicle according to its specifications, this may apply, in order that it may be better compared with a new vehicle or other used vehicles. Likewise, by using the VIN for a vehicle, a user may obtain the specifications and create a label 110b for a used vehicle.

Meanwhile, various proposals from the EPA of the United States require a new label 110c that includes not only economy but also typical data from other emissions, such as carbon dioxide. Moreover, other environmental grading factors as articulated by the EPA and its proposed regulations are reflected therein. Moreover, certain automatic recognition symbols are included so an individual may direct a smart phone or other computerized personal electronic device to access an online computer website in order to obtain additional information.

Meanwhile, safety rating labels 110d as well as disclaimer labels 110e identify the fact that a particular vehicle is, or is not, safety rated. Requirements are published by the Code of Federal Regulations (CFR), and required of manufacturers and/or dealers in labeling.

In Australia, another version of a fuel consumption label 110f includes specific requirements for sizes, fonts, formats, spacing, and the like on labels. In New Zealand, an energy label 110g has a format with ratings by stars indicated according to regulations of the government thereof.

Meanwhile, Canada includes a similar fuel economy rating 110h or label 110h directed to fuel economy. Also, the European Union has a fuel economy label 110m, having its own form, content, and so forth. Other regulatory labels 110j may be required in the future or may be required by other jurisdictions.

There is an entire other group of information that is controlled less but is included as discretionary labeling 110k. For example, what and how a manufacturer chooses to be identified is unique to that manufacturer, the model of product, and so forth. Accordingly, certain other discretionary labeling 110x may also be included in a label 100 where and when appropriate.

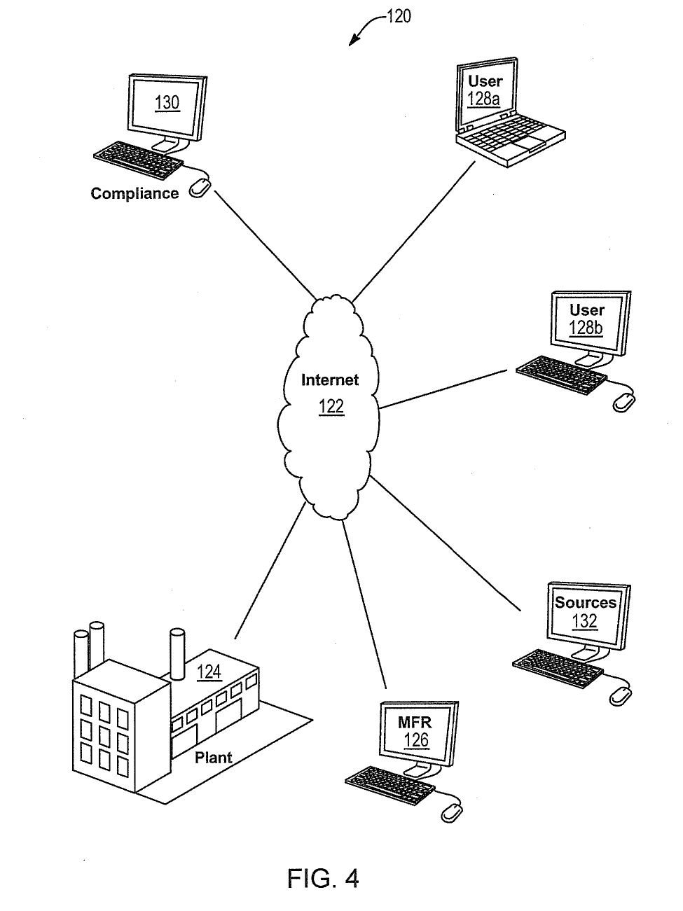

Referring to FIG. 4, a compliance system 120 may operate over the Internet 122 or any other network 122, including a dedicated network, local area network, a wide area network, some other private or virtual internetwork, or the like. However, the Internet 122 is a good example of a specific network 122 in which the operations and the operators thereof need not be affiliated with the same company, organization, or control.

In the illustrated embodiment, a manufacturer may have a plant 124 producing products, such as vehicles, that will be labeled. Meanwhile, a compliance computer system 130 is connected over the network 122 with other computers such as a plant computer 124, another manufacturer's computer 126, whether that is another manufacturer, manufacturer's dealer, or another computer system associated with the same manufacturer, but remote from the plant 124. On the other hand, the manufacturer's computer 126 may actually be a computer in the plant 124 in certain embodiments.

A user computer 128 may be configured as a roaming remote computer 128a or as a user desktop 128b. For example, users may access by smart phone, personal digital assistant (PDA), smartbook, tablet, laptop, or other mobile online device the network 122. Accordingly, a compliance system 120 may rely on a compliance computer 130 obtaining information or inquiries, and providing information to various users 128a.

Typically users 128 or user computers 128 are associated with purchasers, prospective purchasers, future purchasers, previous purchasers, and so forth. In an apparatus and method in accordance with the invention, the information from such user computers 128 may be received as useful. In particular, such users may provide problems, facts, specific experiences, and the like. Similarly, such users may request information from the system 120.

Another important computer system 132, represented here in a single image but which may be represented by many different and distant organizations, is source computers 132. From these, the compliance computer 130 may obtain information. In the illustrated embodiment, information may be collected by the system 120 as particularly directed by the compliance computer 130. In certain embodiments, a manufacturer may also own the compliance computer 130 responsible for the manufacturer's computer 126, the plant 124, or both. In other embodiments, the compliance computer 130 is a completely independent computer owned by an entity providing a service to a manufacturer's computer 126 and ultimately to a plant 124 producing products that must be labeled.

In the illustrated embodiment, the compliance computer may request, download, browse, mine, or otherwise accumulate information from user computers 128, source computers 132, and the like. These are any computers containing information and making in publicly or privately available. Manufacturers 126 may provide information to the public. They may provide information directly to the compliance computer 130 in response to a request, or the like. Likewise, the plant 124 may communicate information provided voluntarily, publicly, privately, in response to a request, or otherwise available to the compliance computer 130.

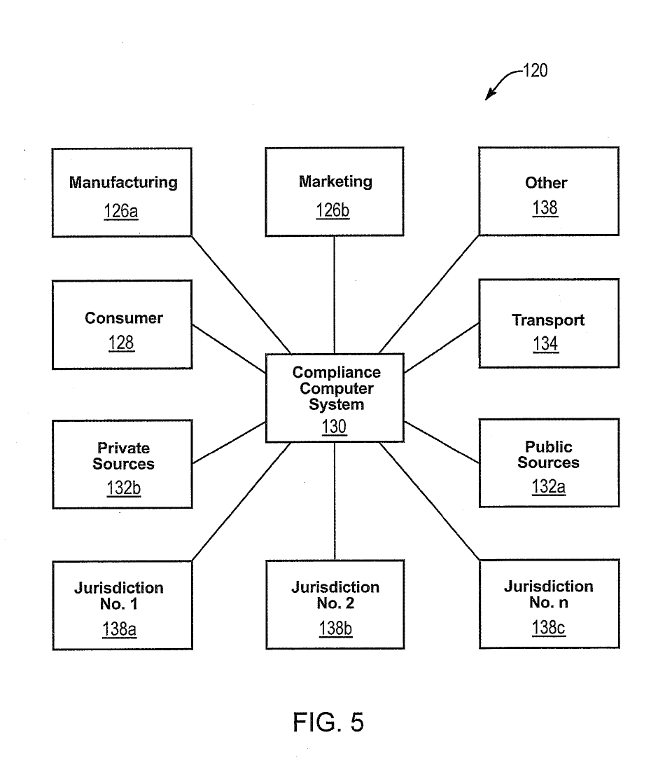

Referring to FIG. 5, the compliance computer 130 may be connected to a variety of modules, whether hardware or software, at any distance. In the embodiment of FIG. 5, the compliance computer system 130 may be considered a module or a software system hosted on a compliance computer system 130. Meanwhile, the other modules may be configured in hardware, software hosted on hardware, or may be data storage provided in association with various other entities.

For example, in the illustrated embodiment, the manufacturing module 126a may correspond to the manufacturer's computer 126a. Similarly, the marketing module 126b may be configured or associated with the manufacturer's computer 126, the manufacturing plant 124, or some other computer, software, or system. However, the responsibility of the manufacturing module 126a is to provide to the compliance computer system the manufacturing information needed to provide compliance with regulatory labeling.

By contrast, the responsibility of the marketing module 126b is to provide discretionary information related to branding and marketing, such as advertising, labeling, logos, and the like that may be provided by a manufacturer having a plant 124. Information about a product being made (e.g., a vehicle) may be created in an office computer 126 to later be included in a label 100, 110 in a manner desired but still being compliant with law. In fact, manufacturers must be identified and will therefore use their preferred names, addresses, logos, and advertising slogans on a label 100.

Meanwhile, marketing information may also come from a marketing module 126b associated with a dealer. A dealer is a downstream reseller of a manufacturer's product having a relationship with the manufacturer, as the supplier, and the consumer, as the buyer of the manufacturer's product. A dealer's address and name identify the typical destination listed on a label 100.

Similarly, the consumer module 128 may typically be associated with a consumer computer 128 of FIG. 4. It may provide information about, or associated with, a particular consumer or group of consumers. Likewise, a consumer module 128 of FIG. 5 may come from a source that tracks consumer information.

The private sources 132b may be associated with private information that is not publicly disclosed. Accordingly, private sources 132b may typically provide information to the compliance computer system 130 in response to inquiries by a compliance computer system 130 or module 130. Similarly, public sources 132a may be queried to provide information from the public source module 132a, which may be provided to the compliance computer system 130 directly, and cooperatively.

On the other hand, public source modules 132a may also be other sources of information that may be mined. They may also publish information to the public that may therefore be used by the compliance computer system 130.

Of particular interest are the jurisdictional modules 138. The jurisdictional modules 138a, 138b, 138c correspond to individual jurisdictions. Any number of jurisdictional modules 138 may be connected to the compliance computer system 130.

As noted herein, the trailing lowercase letters associated with certain reference numerals in the drawings represent specific instances of the item articulated or identified by the reference numeral. Accordingly, it is proper herein to use a reference numeral alone to include the entire class or type of item identified by the reference numeral to use a reference numeral with trailing letter to call out a specific instance thereof, or a characteristic common to all instances.

The jurisdictional modules 138 correspond to various jurisdictions, and particularly to sources of law by statute, regulation, or the like. Accordingly, a first jurisdictional module 138a may be associated, for example, with a manufacturing jurisdiction. This may be a province or state but will typically be associated with a country. It may be a government module that provides national statutory and regulatory information.

In contrast, another jurisdictional module 138b may correspond to a separate country having its own national jurisdiction with its own regulations, statutes, and so forth. Typically, for example, a vehicle or other product may be manufactured in a first jurisdiction, and be governed during manufacturing by the laws and regulations provided from the jurisdictional module 138a.

Typically, the jurisdictional module 138a will be a system of information provided by a national government responsible for disseminating that information to the public. Likewise, the jurisdictional module 138b is a system of information, and delivery of that information by another jurisdiction. Typically, this second jurisdiction module 138b may be affiliated with a destination country. Accordingly, the national laws, statutes, regulations, and so forth of that second jurisdictional module 138b will be different in some respects and common in some respects to the information received from the manufacturer's first jurisdictional module 138a.

Ultimately, any number of jurisdictions, and therefore the jurisdiction number “n” module 138c may have a website providing information, may have public statutes that may be read into a computer, but will typically have governmental information directed to consumers, manufacturers, compliance officers, and government enforcement agencies.

In certain embodiments, various jurisdictional modules 138 may actually pertain to agencies. For example, the EPA in the United States has certain regulatory authority over vehicle engines' operation. In contrast, the National Highway Traffic Safety Administration (NHTSA) has jurisdiction over structural crash worthiness of vehicles. These are both government agencies of the same government but represent different jurisdictions within that government. Various jurisdictional modules 138 may exist throughout countries, throughout that country's subordinate jurisdictions, and so forth.

In certain embodiments, a transport module 134 may be associated with a transporter, a clearinghouse, or an agency response for transportation. For example, transportation information is provided for inclusion on certain products. Initial requirements investigated, which gave rise to the law that now regulates product labeling for vehicles, centered on various cost issues, including transportation charges. Thus, the Department of Transportation (DOT) as well as various tariff agencies may run computers having modules 134 that effectively operate as transport modules 134 providing information that may be used by the compliance computer system 130.

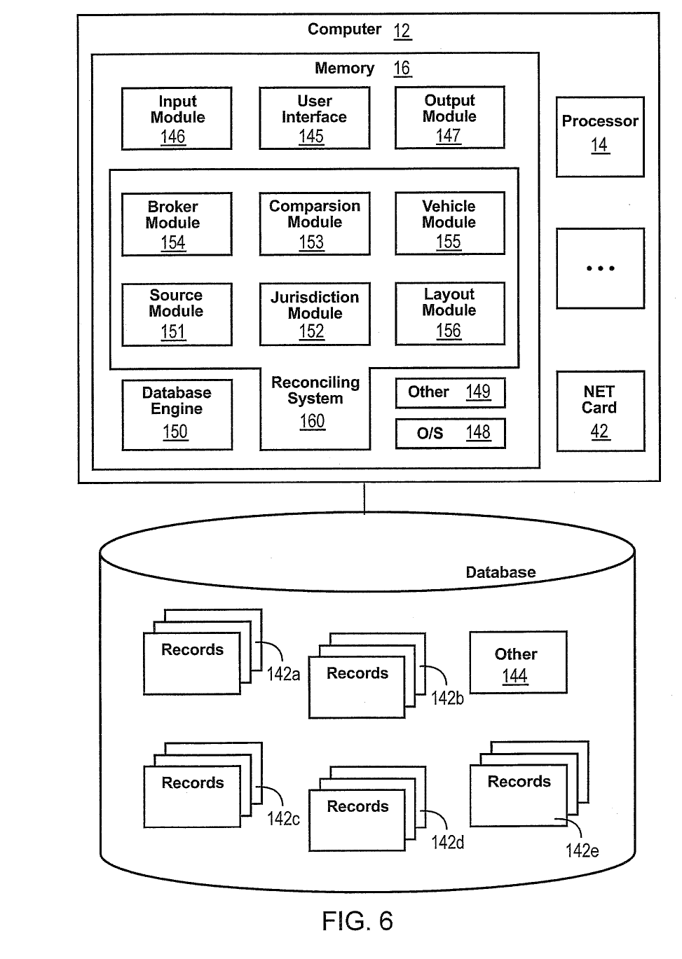

Referring to FIG. 6, in one embodiment, a computer 12 used, for example, as a compliance computer system 130, may be embodied in a single machine in a single location, as various processes in a single machine, as various processes in different locations, as different machines, or as various types of machines. Nevertheless, some modules that may be useful in such a computer 12 may include a database 140. Typically, the database 140 will be maintained by the computer 12, also identified as the compliance computer system 130 responsible to assist in obtaining compliance with selected regulations.

In the embodiment of FIG. 6, a database 140 may include various records 142. The records may be associated with, and reflect the information pertaining to, any particular thing, product, entity, or the like. For example, various manufacturers may have various records reflecting facts about the manufacture of a product. Likewise, vehicles may have records 142 reflecting classifications of those vehicles, individually, as a class, or as a particular brand name or model name. Likewise, the database 140 may store records regarding sellers, resellers, dealers, and the like for particular products. Likewise, the database 140 may include records 140 corresponding to various individual plants 124, manufacturers 126, or other entities providing information or needing information from the compliance computer system 130.

In one implementation of an apparatus and method in accordance with the invention, the compliance computer system 130 may include a computer 12 having a processor 14, or various processors, consolidated, in a single machine, or distributed over several machines. With access to the network 122 through network card 42, the compliance computer system 130 may store in memory 116 various modules for execution on the processor 14.

In the illustrated embodiment, a user interface 145 may give access to the compliance computer system 130. Likewise, an input module 146 may determine, request, or receive the information to be provided to the computer system 130 by any one (e.g., person or computer) accessing the user interface 145. In certain embodiments, individuals may be reporting on behalf of an entity or may be investigating information.

An output module 147 provides outputs from the computer system 130 to any entity, or any module identified that needs information from the computer system 130 and is entitled to obtain it. In certain embodiments, the user interface 145 may be a browser, but may be a dedicated client module 145, a dedicated software application 145, or the like. Regardless, the input module 146 provides formatting, requests, queries, responses, formatting, reports, and the like, and may submit queries in order to obtain inputs for the computer system 130. Meanwhile, the output module 147 may provide output such as data or label information to users, administrators, manufacturers, or others who access the computer system 130.

In the illustrated embodiment, a computer 12 requires an operating system 148, in order to access information, and other software modules 149 may also be included. However, the modules of more interest, in accordance with the present invention, pertain primarily to the database engine 150 and the processing of information in order to obtain the compliance to which the compliance computer system 130 is directed.

For example, in certain embodiments, a source module 151 may be responsible to interact with the sources 132 providing information to the computer system 130. Similarly, a jurisdictional module 152 may be responsible to interact, query, and otherwise interact with the jurisdiction modules 138. For example, the compliance computer system 130 may have a system of modules that automatically update, query, search, mine, communicate, or otherwise collect information needed by the computer system 130 in order to assist in and effect compliance with regulatory labeling.

In certain embodiments, a comparison module 153 may be responsible to compare the requirements of the various jurisdictional modules 138. Once the jurisdiction module has accumulated the information, the comparison module 153 has a largely mathematical process to compare the information received in order to determine what applies.

Fore example, the comparison module 153 does the processing in order to compare for any particular product that is to be labeled, the various requirements, which may be inconsistent, may be stronger or weaker between various jurisdictional modules 138, or the like.

Accordingly, when conflicts arise, a broker module 154 may be responsible to process information from the comparison module and broker the priorities. For example, generally, the comparison module 153 is responsible to determine comparisons. However, the broker module 154 may be responsible to make decisions that may bear on law and so forth. Thus, the broker module 154 is largely responsible for reconciling and choosing the means by which regulations will be obeyed and the rationale therefore. Accordingly, the broker module 154 may be responsible to document the regulations considered, the sections thereof considered, and the reasons for selecting one particular regulation over another as the controlling element for compliance.

Of course, the product involved will benefit from a product module 155, shown in the example here as a vehicle module 155. The product module 155 or vehicle module 155 is responsible to document, fill in, acquire, or otherwise process the vehicle or product information that will be required. For example, much of the information in the jurisdictional module 152 will be a matter of factual requirements of law. Likewise, the vehicle module 155 may largely provide facts in a format such that the comparison module 153 may use that information and so the broker module 154 may process any conflicts in information or requirements.

All of the modules in the compliance computer system 130 may access records 142 in the database 140. In fact, the various other modules 144 in the database 140 may include software, software updates, other information libraries that need to be maintained in order for the software modules operating to have updated information, to receive updates, to be stored, to be accessed, to be launched, and the like. Accordingly, in addition to records 142, the database 140 may also include other files 144 that contain executable instructions.

The layout module 156 is responsible for determining a layout for a label 100, and specifically, for a regulatory label 110 such as a Monroney sticker 110, which is specified in such detail. For example, in various jurisdictions, the font size, the appearance, the particular typeface of the font, various characters in certain portions of the label, the distances, the overall extent of the label, and the like are established by regulation. Accordingly, in a system 120 in accordance with the invention, a computer system 130 is tasked with complying with regulations in multiple jurisdictions. If those regulations can be satisfied with a single label 100, that is good. However, if those regulations cannot be complied with in a single label 100, then it may be required to make two labels.

Typically, the layout module 156 is responsible to use the space available, in view of the regulated appearance, spatial relationships between the fields 101, the font sizes, and the content. It develops a negotiated space plan compliant with all the required regulations and still fits the information in an optimal or standardized space on a label 100.

Together, the modules 151-156 make up a reconciling system 160 or reconciliation system 160 that effectively provides the information in a format and properly laid out in order to publish, print, or otherwise manufacture a proper label 100.

In order to do so, the compliance computer system 130 provides access to users, with the provision of inputs and outputs in order to interact with the reconciling system 160.

In turn, the reconciling system 160 relies on the database engine 150 to access the database 140 to retrieve information from the records 142 and to return information to various records 142. Likewise, the reconciling system 160 may rely on the database engine 150 to provide other modules 144 that will be loaded and run on the processor 14 in order to make calculations, determine information, assist in making decisions, and so forth.

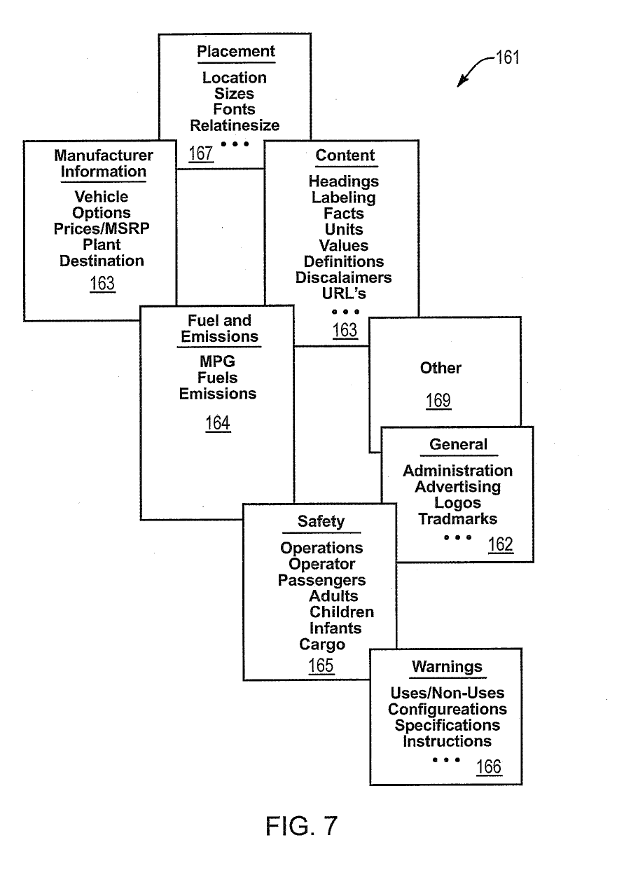

Referring to FIG. 7, information 161 may include various types. For example, general information 162 may include administration information associated with labels 100. Administrative information 162 applies in several respects. Reviewing a Monroney label 100, for example, one notes various information regarding addresses, form numbers, certification numbers, administrative tracking numbers, factory identification information, websites, disclaimers, consumer information phone numbers, and manufacturer identification. This kind of information may be the province of administration information 162 to be used by the compliance computer system 130. It is considered in deciding and executing the decisions required to make a label 100. Similarly, information such as advertising, logos, trademarks, and the like may be general discretionary information that is maintained but is not required.

In general, manufacturer information will be available, including certain discretionary information that an advertiser may use. For example, manufacturers would certainly have some decision as to what logos, labels, trademarks, and the like appear on the label 100 associated with a particular product.

For example, in the example of a vehicle, the name and other identifying information, from model name to VIN, as well as options, pricing information, the MSRP, the manufacturing plant, the destination location, and the like may be considered manufacturer information and may be stored therewith.

Fuel and emissions information 154, such as the miles per gallon or the kilometers per liter of fuel, the type of fuel, the fuel consumption rating or comparison with other vehicles within a particular manufacturers line or other comparative vehicles, may also be included. Likewise, emission information of any and all types may be included in the fuel and emission information 164. Typically, this information 164 will be that data and consumer information that is required by law, and is of interest to purchasing consumers who are buying the product represented by the label 100.

Similarly, safety information 165 may include the government safety rating 106, or the crash rating 106 as it is commonly called. Likewise, other information may address operation of the car, operator limitations, demands, or abilities, limitations on activities or placement of passengers, such as where adults may be seated, how the children must be seated, and protections available for infants. These all may be considered in safety information. In some vehicles, even passenger vehicles, certain warnings regarding cargo and vehicle conditions are also available. Thus, the safety information 165 may be stored in the database 140 in order to be used to print various labels 100.

Meanwhile, various warnings 166 regarding the use or non-use of particular equipment may be included. For example, how to shift a 4-wheel-drive transfer case may be required information for a label, a tag, a sticker, or the like. Similarly, various configurations, including what the model designation provides by way of features like braking, backing, parking, and the like may be included in warning information 166. Likewise, certain specifications, certain instructions, and so forth may all be included in the warnings 166.

In addition, placement information 167 may relate to location, size, font, relative size, and so forth of various text, images, labels 110 included within the overall label 100 and other information that is to be used in various fields 101 of the label 100.

Placement information 167 may be very specific to a particular vehicle as well. For example, regulations may require a specific one, or a limited choice for the location. Regulations do require the location of placement of a Monroney sticker label 100 to be in the statutory or regulatory system's specified location.

However, by the same token, vehicles have different sizes of windows. A tiny sports car has a substantially smaller layout of glass in the various windows and windshield compared with a cargo truck. Specifications of sizes and shapes of the windows on which labels 100 are to be installed may be contained in the placement information 167.

Similarly, the content information 168 may include the required headings, various labeling information, facts, units, and the like. For example, in some countries, metric units may be required. In others, English units are more common, and even statutorily specified. Likewise, the actual values of various figures will be included. Similarly, definitions and disclaimers may be required in order to advise a consumer how to read a particular label 100.

In addition, phone numbers, URLs, where regulatory agencies, manufacturers, or other help may be accessed may be included in the content information 168 that will eventually find its way into the labels 100.

Thus, a variety of information, including the information previously discussed hereinabove, as well as certain other information 169, may be collected, stored in the database 140, and otherwise made available to the compliance computer system 130 in order to be able to develop, reconcile, and print a label 100 compliant with the jurisdictional requirements of the manufacturer and the dealer, as well as the purchaser.

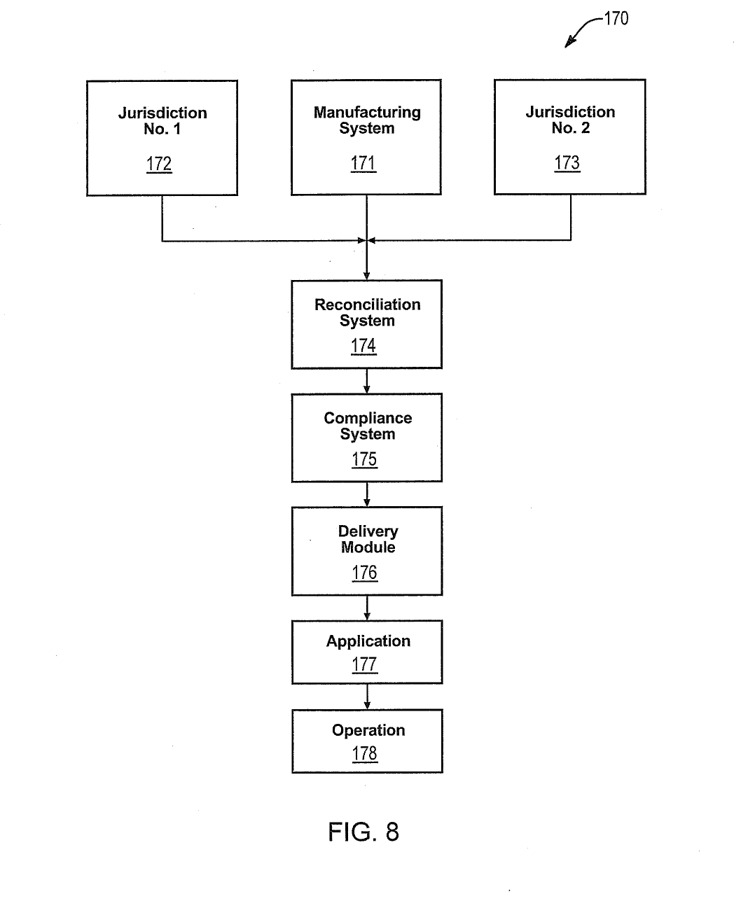

Referring to FIG. 8, a process 170 or method 170 in accordance with the invention may include jurisdiction inputs 172, 173, as well as manufacturing system inputs 171 into a reconciliation system 174 or process 174. For example, the reconciliation system 160 may execute the reconciliation process 174. Accordingly, a compliance process 175 may be executed by a compliance computer system 130 in order to deliver 176 a label 100.

In the illustrated embodiment, the process steps 171-178 may be represented by modules, computers, software, or the like executing the process steps 171-178. Thus, one may view FIG. 8 as either a series of steps or as a series of software or hardware elements responsible to execute those steps.

Thus, ultimately, delivery 176 is followed by application 177 of the sticker 100 and operation 178 of the product. In the illustrated embodiment, the jurisdictions are only two, but any number of jurisdictions may be handled.

Typically, the processes of the method 170 or the system 170 may be implemented in hardware, software, in a single computer, in multiple computers, in a single executable application, or in multiple parts.

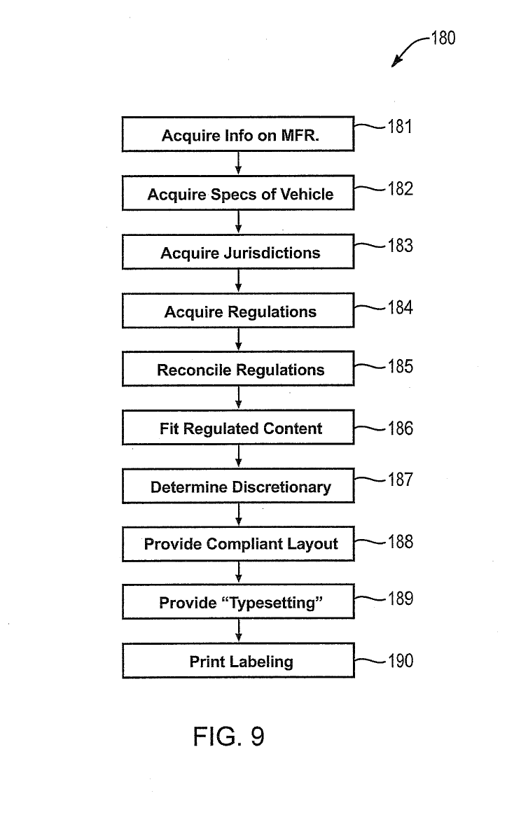

Referring to FIG. 9, a process 180 for creating a label 100 may involve acquiring 181 information regarding the manufacturer. One may also consider information 181 provided to the systems 120, 130 regarding dealers or others down stream who act as representatives, agents, or resellers for a manufacturer.

Likewise, acquiring 182 the specification for the vehicle, including all of its technical facts, identifying information, and the like may be necessary in order to properly prepare a label 100. Meanwhile, acquiring 183 the jurisdictional information or the jurisdictions will be particularly important where a product will cross national or other jurisdictional boundaries. A standardized label 100 may be inadequate. Where the model name, the technical specifications, and the like are not changed, changes may be required simply because the product, such as a vehicle, travels across the jurisdictional boundaries of national sovereignty. Likewise, jurisdictional information may be acquired 183 in order to know what information is required on a label 100 within each of the jurisdictions. Thus, typically, a label 100 will be quite specific to the jurisdictions that a particular product will see. Notwithstanding, there is some attempt periodically by countries to identify by a treaty information on which they will cooperate. Nevertheless, every sovereign nation develops its own regulatory scheme requiring the acquisition 183 of jurisdictional information requirements.

Acquiring 184 the regulations, laws, statutes, and other compliance information required by label 100 follows from the jurisdictions 180 jurisdictions acquired 183. By acquiring 183 jurisdictions is meant acquiring 183 the information required to satisfy the regulatory scheme of that jurisdiction.

Reconciling 185 the regulations against each other while also reconciling 185 those regulations with the commercial needs of the manufacturer, dealer, and the like is representative of a range of decisions. For example, a manufacturer or dealer wants certain information available. Regulations require other information to be available. Regulations also require certain information to be in a certain place, and in a certain format, which may preclude other information desired by manufacturers. Accordingly, reconciling 185 the regulations against all information to be placed in label 100 is an exercise in simplifying complexity.

Fitting 186 the regulated content into a label 100 may be accomplished by the layout module 156 of the compliance computer system 130. Thus, fitting 186 the regulatory content is going to be a requirement of each jurisdiction.

Next, determining 187 the discretionary content desired, permitted, and that will fit is a follow on that may be included in the label 100, or may have to be handled otherwise. In the illustrated embodiment, after determining 187 the discretionary content, then providing 188 a layout is possible.

Providing 188 a compliant layout involves providing 188 all of the required regulatory information with as much of the discretionary information determined 187 by the system 130. Regulatory information is required. Discretionary information is desired. To a certain extent, discretionary information for a manufacturer or dealer may be important marketing information, without which the label 100 does not do its full duty to the manufacturer or dealer. Thus, providing 188 a compliant layout may provide 188 certain options, in which the manufacturer may then determine 187 certain discretionary information, by returning to the determining step 187, to choose between available options, on aesthetic, marketing, or other selection basis.

Providing 189 typesetting involves more than actual typesetting but provides the fonts, the spacings, and so forth in accordance with the layout that has been provided 188. This is the printing setup, except for the actual printing sent to a printer. Thus, by printing 198 a label 100, one commits to a substrate, a receiving material, the printing ink, with the information printed on the substrate as provided 189 in the typesetting.

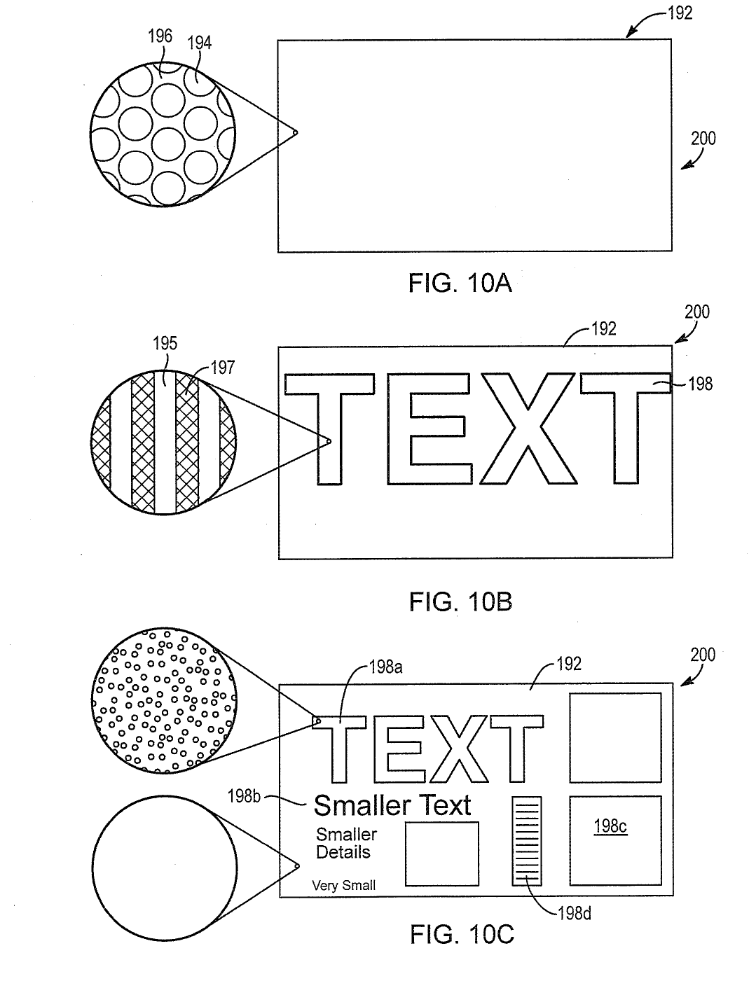

Referring to FIGS. 10A, 10B, 10C, various embodiments of a substrate 192 may be used. Meanwhile, the substrate 192 may be clear, opaque, thick, thin, or the like. Typically, a substrate 192 may be thin, a film or sheet of the order of magnitude of a plastic decal. The substrate 192 may be formed of a polymer or may be formed of paper. However, the construction technique will vary accordingly.

In certain embodiments, the substrate 192 may be provided with apertures 194 or ink dots 194. Thus, for one example, just as a vehicle wrap provides an opaque substrate 192, a substrate 192 may be provided with numerous perforations 194 that act as gateways to pass light through the substrate 192. In other embodiments, the substrate 192 may be a clear, transparent polymer, and thus only the pigments need to be applied as dots 194. Thus, the circles 194 represent dots 194, or apertures 194, depending on the nature of the substrate 192.

For example, in certain embodiments, the substrate 192 may be a fabric provided with many apertures 194 therein. In such an embodiment, the fabric 192 may be printed but will receive ink only on the matrix 196, on actual material. The apertures 194 will not carry any pigment.

In an alternative embodiment, the substrate 192 may be a transparent film 192. Accordingly, dots 194 may occupy a certain portion of the area 192 in order to provide the colors and images corresponding to text, logos, and so forth required in the label 100. By precision location of the dots 194 on a transparent substrate 192, an image reflects sufficient light to a reader standing outside a vehicle or looking at a product. This also allows transmission of light to a driver inside the vehicle 202 while still providing a reflected image from the dots 194 of pigment directed toward a viewer outside. Thus, a panel 200 may receive the information printed thereon to make the panel 200 into a label 100.

Referring to FIG. 10B, while continuing to refer generally to FIGS. 1-17, in certain embodiments, a substrate 192 may receive stripes 195, 197 operating much as the apertures 194 and matrix 196. In this case, the distribution may not be in two dimensions. Rather, very thin lines 195, 197, stripes 195, 197, or striations 195, 197, one with pigment and one with no pigment, basically divide the light. A certain amount of the light striking the front face of the substrate 192 will be reflected from the opaque stripes 197 while the transparent stripes 195 will pass light through the transparent substrate 192. In this way, text 198 may be printed on the substrate 192 but only on the very thin stripes 197 to be opaque. Such striping is not distinguishable typically to the eye but nevertheless reflects light back to the reader.

Referring to FIG. 10C, in another embodiment, the substrate 192 may simply be entirely transparent in the open space. Thus, it does not operate as a shade. Accordingly, the text 198a of the larger variety may simply be applied either as opaque or as preferentially transparent and opaque on opposite sides as described above with respect to FIGS. 10A and 10B. That is, the large expanses of text 198a or images 198c may pass some light through and reflect other light back.

By the same token, very small print 198b or smaller text 198b and the lists in fine print 198d or large expanses of print 198d may simply be left, since they can be serving the same function as the dots 194 or reflected stripes 197, themselves, passing light around themselves through the transparency of the substrate 192.

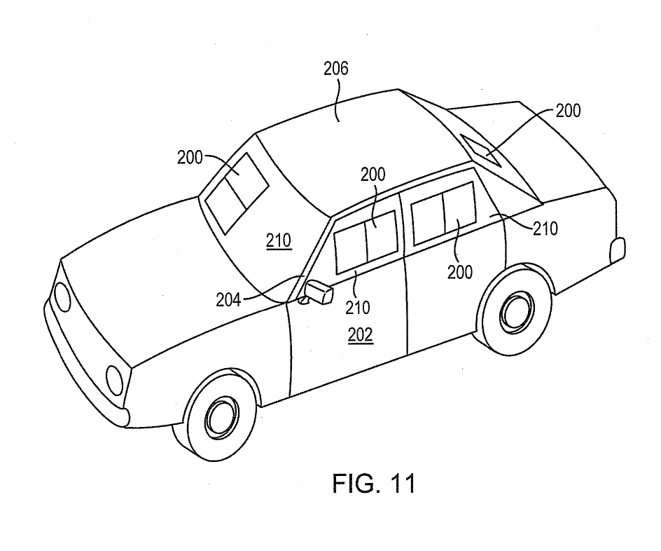

Referring to FIG. 11, while continuing to refer generally to FIGS. 1-17, a product, such as a vehicle 202 may be labeled with a panel 200 in accordance with the invention. The panel 200 is a specialized form of a label 100, and in particular, a regulatory label 110. In the illustrated embodiment, the panel 200 may be positioned in a particular vehicle 202, having structures 204, such as support for the roof 206 and containing various windows 210. A panel 200 may be placed against the inside surface of a window 210 in the vehicle 202.

Due to the existence of a roof 206, there is already less light inside the cab, cabin, or interior of a vehicle 202 than is usually available by ambient day light outside. Regardless of the outside lighting conditions, except, possibly, at night, the power of sunlight provides much more light to a reader of the panel 200 than is available inside the vehicle 202. Thus, the embodiment of FIG. 11 illustrates several places, one or more of which, may be used for various panels 200. Likewise, multiple labels 100 are shown in the panels 200, inasmuch as multiple labels are often used in labeling vehicles 202.

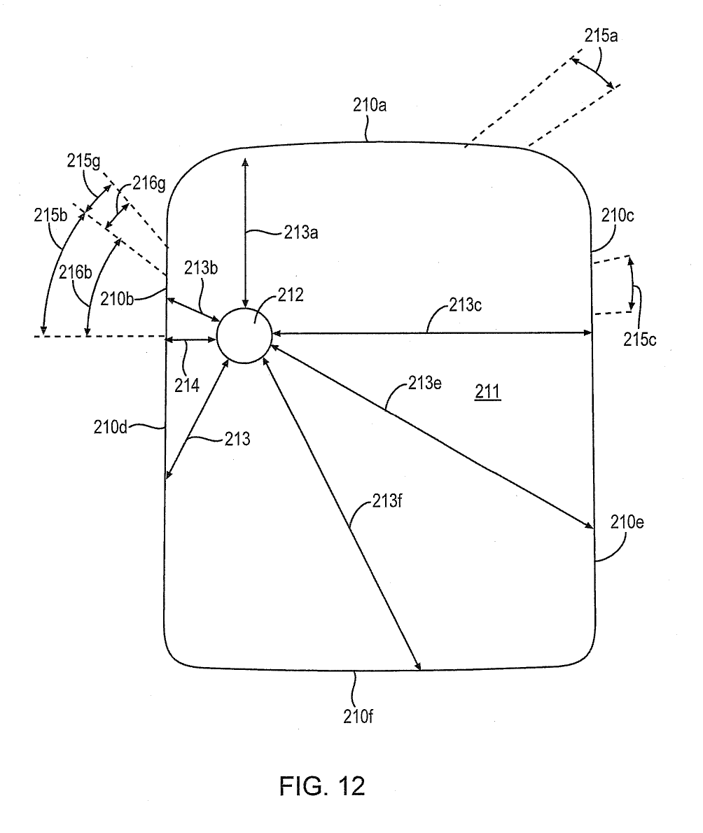

Referring to FIG. 12, a cab 211 of a vehicle may typically offset the driver head position 212 away from the center, in both the right-to-left directions, and the front-to-rear directions. Thus, for example, in the United States, the position 212 of a driver's head is very close to the left side of the cab 211 and closer to the windshield 210a. For example, the left side window 210b is a matter of about ten inches from the position 212 of a driver's head. In contrast, the windshield 210a is typically three, four, or more feet away from the position 212 of a driver's head.

Each of the windshield 210a, driver left window 210b, and driver right window 210c, which is the front passenger window 210c, is a windows 210 relied upon by an operator of a vehicle 202. Meanwhile, occasionally, for purposes of checking during a lane change, a driver may check a left rear window 210d or right rear window 210e. Typically, only in backing or in checking a rear view mirror does a driver turn around sufficiently to see out a rear window 210f.

Each of the windows 210 presents a different subtended angle 216 as a result of any label 100 placed in that window 200. For example, a typical label placed in the driver's left window 210b is spaced a distance 213b of about five to fifteen inches from the position 212 of the driver's head. The distance 213a from the windshield 210a to the position 212 of the driver's head is about four feet in a small sedan. These dimensions correspond, to a certain extent, to the uprightness of the posture or positioning of a user in the seat, the distance of the seat of a vehicle 202, based on the length of a driver's legs, and so forth.

One will note that the distances 213 to the various windows 210 are longer and shorter, with respect to one another. The perpendicular distance to the pillar, which is typically located beside the driver's head position 212, is a distance 214 of the center of the body of a driver to less than the distance to a shoulder. Typically, in human factors engineering, the width of a human person is considered to be about twenty two to twenty four inches.

Thus, from the center of the driver's head or the center of the driver's head position 212 to the window, was about twelve inches in cars of half a century ago. However, with the advent of smaller cars and more aerodynamic designs, windows 210 now curve much more, and curve inward, such that the distance 214 to the body pillar of a vehicle 202, and the distance 213b to the left driver's window, may actually be a matter of only a few inches, in the low single digits.

The subtended angle 216b of a label 100 thus creates a very long blockage 215 or blind spots 215 to the vision of a driver. In contrast, the blocked distance 215a through the passenger side of the windshield 210a is much less, as is the blocked space 215c through the right window 210c. In any event, each of the blocked regions 215 represents an area that cannot be reliably seen.

Pedestrians, motorcycles, bicycles, and the like have very narrow profiles, typically about the human width of about two feet. Thus, the blind spots 215 are significant. In certain embodiments, additional labels cause additional subtended angles 216g in addition to a principal label 100 with its blockage 216b. In one embodiment of an actual vehicle investigated by Applicant, a major portion of the entire left window 210b was obstructed by two labels, one being a Monroney sticker 100 and the other being an additional EPA-mandated gas-guzzler designation and information sticker.

In accordance with an apparatus and method in accordance with the invention, an additional method and apparatus in accordance with the invention provide for a panel 200 to transmit light through to a driver so as to be transparent, or effectively so, to a driver or passenger within a vehicle 202.

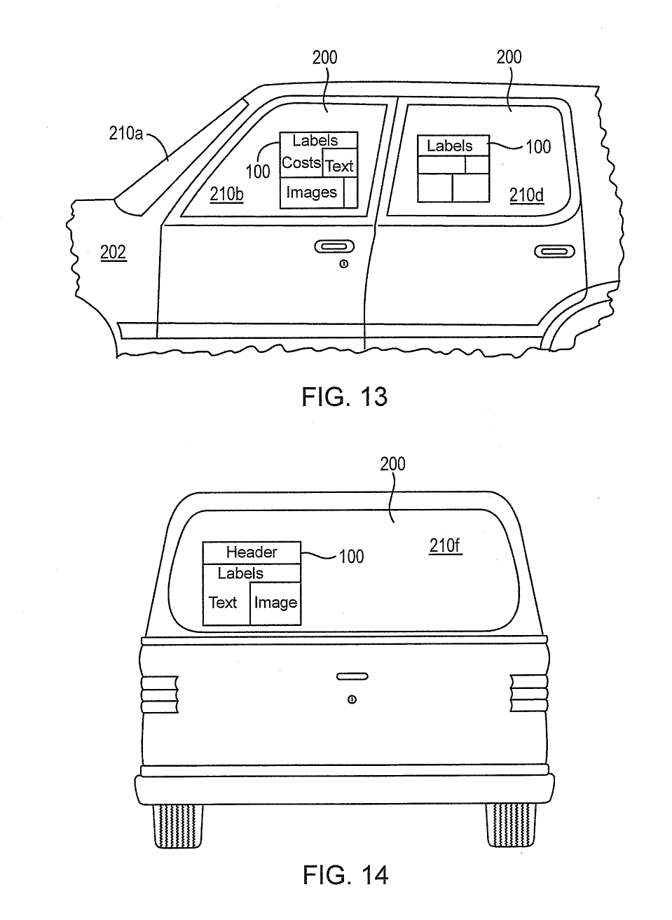

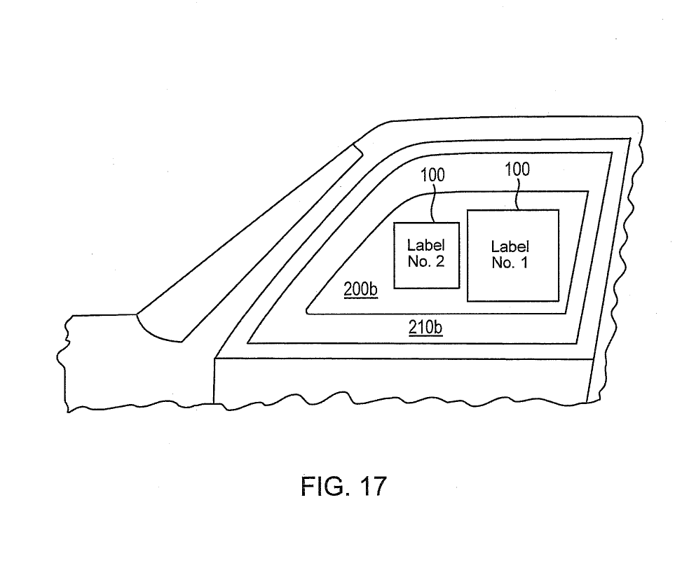

Referring to FIGS. 13-17, while continuing to refer generally to FIGS. 1-17, a panel 200 may include a label portion 100 thereof, in a window 210 of a vehicle. For example, referring to FIG. 13, the view of the labels 100 on the panels 200 is effectively opaque. The brighter sunlight outside causes sufficient reflection that a user's eyes will be overwhelmed by the reflected light from the overall panel 200. In the illustrated embodiment of FIGS. 13-16, the panel 200 fills the entire window. FIG. 17, in contrast, illustrates an embodiment where the panel 200b fills less than the window but is generally shaped in order to handle the common narrowing toward the forward part of a vehicle window 210.

In FIG. 13, the panel 200 effectively fills the window 210, but only the label 100 is printed with information. Thus, the panel 200 provides a shade to a user, ensuring that the eyes of the user do not adjust to outside light but rather adjust to filtered, shaded light as filtered by the panel 200, as described with respect to FIGS. 10A-10C.

Similarly, the rear view of FIG. 14 shows a panel 200 completely covering substantially the inside surface of a window 210f. Meanwhile, the label 100 is printed on the panel 200. The panel 200 provides a shade for the window 210f and thereby ensures that the eyes of the driver inside adjust to a single level of light through that window 210f and therefore may see through the panel 200 and the label 100 almost as if they were transparent. As a practical matter, the panel 200 cuts down on (shades) a portion of the light available to a user. Nevertheless, due to the outside brightness, a user can see through the panel 200. In some embodiments, the panel 200 may actually be completely transparent.

In such embodiments, the panel 200 may be of any particular size, and only the printed area of a label 100 need have opaque dots 194 or a matrix 196 to reflect light back to a reader on the outside of the vehicle.

It is proper to refer to a driver, and a reader, even though they may often be the same person. Typically, a driver is an individual sitting in a vehicle 202 and driving it on a test drive. The labels 100 and panels 200 are removed after purchase. However, as long as a vehicle 202 is being test driven, the panels 200, labels 100, or both are still attached, being required to remain in place until removed by the final purchaser. Likewise, readers include all those shoppers who stop to look at a product, such as a vehicle 202, and they need to be able to read the required information on the labels 100.

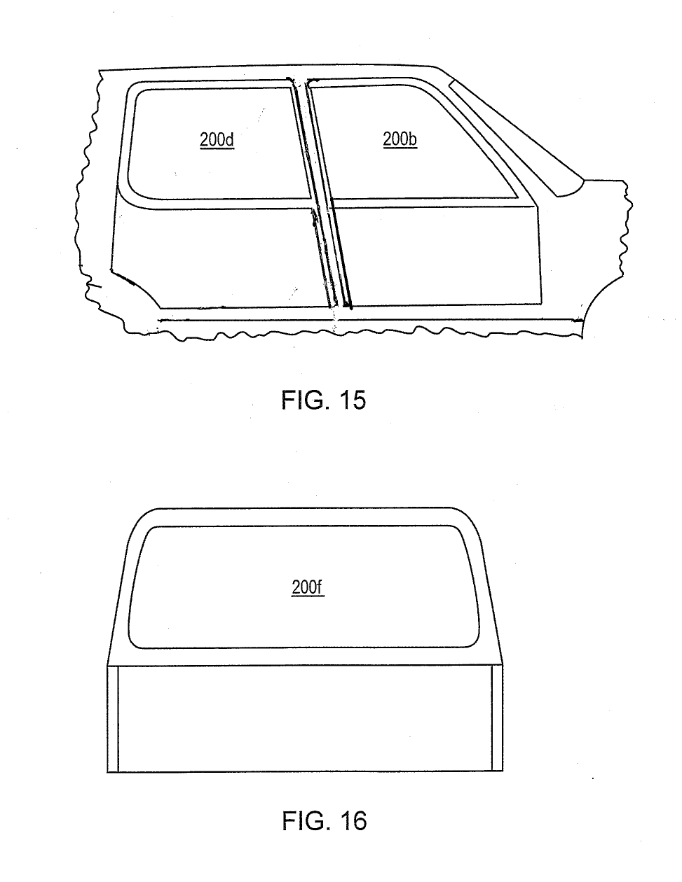

Referring to FIGS. 15-16, the views from the inside corresponding FIGS. 13-14, respectively, are shown as seen by the eye of a driver. Here, the view presented to the user in the panels 200b, 200d, shows a window. To the user, the back side of any substrate 192 used in a panel 200, of any extent, is typically of a single color and does not represent images visible with outside color. In some circumstances, some of the color of the label 100 may be detected from within the cab 211 of a vehicle 202. Nevertheless, in general, the rear window is not seen directly, as illustrated in FIGS. 16, since the panel 200f covers the window 210f. Likewise, the panels 200b, 200d cover the windows 210b, 210d of the vehicle 202.

Of course, the embodiment of FIG. 11 may involve only the panels 200 covering the same extent as (coextensively with) the labels 100. In such an embodiment, the panel 200 may be bounded by the same dimensions as the label 100, making them completely coincident or coextensive and further reducing any obstruction of light or view.

One consideration for the embodiment of FIGS. 13-16 in view of the configuration of FIG. 11 is that the embodiment of FIG. 11 permits more light to pass around the panel 200, whichever position it may have, or however many panels 200 may be required. Thus, a user's eyes adjust to outside light through transparent windows 210. A benefit of having entire coverage of a window 210 by a panel 200 is that a user's eyes are accustomed to a single level of light, and no part of that window 210 needs to pass any different amount of light than any other portion. Thus, a user's sight is not inhibited by eyes being adjusted to brighter light passing through the window 210 outside of the panel 200.

Referring to FIG. 17, an alternative embodiment, provides a panel 200b that effectively operates as a shade 200b of only a portion of the window. This is a compromise between the configurations of FIG. 11 and FIGS. 13-16. In this embodiment, along the levels corresponding to the driver's head, a panel 200 extends through most of the area. In this embodiment, the panel 200b need not be closely fitted to the window 210b in shape or extent. It merely provides a shape for panel 200 that covers the driver's view, in order to provide somewhat consistent shading. This a consistent level of light may extend forward without an exact fit to the window, for improved sight by the driver.

Labels 100 may be printed as described hereinabove or by any other technique known in the art in order to make the pass-through or transmissivity of light appropriate. Reflection outside obtains readability of the label 100 from outside the window 210b. Sufficient transparency or transmissivity of information and images through the window panel 200b to a driver inside is effective for maintaining safety. The panel 200, whether exactly coextensive with the label 100, or larger, or fitted to a window 210 doubles as a shade.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus comprising:
a panel, having a first face and a second face;
a label, formed as a product label printed on the first face;
the printing, presenting labeling information corresponding to first regulatory information directed to at least one of content, format, and application of the product label; and
the panel and printing, formed to be effectively transparent in use, when viewed from the second face.

2. The apparatus of claim 1, wherein the panel, is further formed and shaped to provide a sun shade in use, reducing transmission of light impinging against the first face

3. The apparatus of claim 1, wherein the panel is formed of a material selected from plastic film, fabric, and another material, the other material being transparent.

4. The apparatus of claim 3, wherein the printing comprises a first pigment and a second pigment.

5. The apparatus of claim 3, wherein the first pigment acts as shading, obscuring substantially a view of the second pigment when viewed from the second face.

6. The apparatus of claim 3, wherein the printing is applied selectively to provide gaps in coverage of a pigment of the printing.

7. The apparatus of claim 6, wherein the gaps are selected from circles, borders of circles, and stripes.

8. The apparatus of claim 7, wherein the gaps transmit light impinging thereon.

9. The apparatus of claim 8, wherein the printing blocks most of the light impinging thereon from the direction of the first face.

10. The apparatus of claim 9, wherein the absorptivity and reflectivity of the printing are effective in combination to block at least half the light impinging thereon.

11. The apparatus and method of claim 10, wherein the panel is formed of a material effective to reflect sufficient light to appear as a contrasting color with respect to the printing.

12. A method comprising:
providing an apparatus comprising a combination product label and shade, the apparatus comprising
a panel, having a first face and a second face,
a label, formed as a product label printed on the first face,
the printing, presenting labeling information corresponding to first regulatory information directed to at least one of content, format, and application of the product label,
the panel and printing, formed to be effectively transparent in use, when viewed from the second face, and
the panel, further formed and shaped to provide a sun shade in use against transmission of light impinging against the first face; and
applying the apparatus to a product in a location within the field of view of a consumer of the product.

13. The method of claim 12, wherein the product is selected from the group consisting of a vehicle and a medication contained in a transparent container.

14. The method of claim 13, wherein the panel is formed of a material selected from plastic film, fabric, and another material, the other material being transparent.

15. The method of claim 14, wherein the printing comprises a first pigment and a second pigment.

16. The method of claim 14, wherein the first pigment acts as shading, obscuring substantially a view of the second pigment when viewed from the second face.

17. The method of claim 14, wherein the printing is applied selectively to provide gaps in coverage of a pigment of the printing, the gaps transmitting light impinging thereon.

18. The method of claim 17, wherein the gaps are selected from circles, borders of circles, and stripes.

19. The method of claim 17, wherein:
the absorptivity and reflectivity of the printing are selected to attenuate a portion of the light impinging on the first face; and
the panel is formed of a material effective to reflect sufficient light to appear as a contrasting color with respect to the printing.

20. A system comprising:
a processor and memory, the memory comprising a computer readable storage medium;
a network connection effective to operably connect the compliance computer system to an internetwork;
the internetwork is further operably connected to a manufacturing computer corresponding to a manufacturing plant producing a product;
the processor is further operably connected to a first source computer corresponding to a first source of first legal requirements enforceable by a first governmental agency corresponding to a first jurisdiction;
the processor is further operably connected to a second source computer corresponding to a second source of second legal requirements enforceable by a second governmental agency, corresponding to a second jurisdiction;
the memory stores, for execution by the processor, a jurisdiction module effective to obtain from the first source computer and the second source computer the first and second legal requirements, respectively;
the memory stores, for execution by the processor, modules comprising a reconciling module effective to compare and reconcile the first legal requirements against the second legal requirements; and
the processor, further programmed to provide to the manufacturing computer a compliance instruction effective to comply with both the first and second legal requirements.
